(19) United States
(12) Patent Application Publication
(10) Pub. No.: US 2012/0267489 A1
(43) Pub. Date: Oct. 25, 2012

(54) CONNECTOR MOUNTING APPARATUS WITH EMI SHIELDING CLIP

(75) Inventors: YA-NI ZHANG, Shenzhen City (CN); CONG CAO, Shenzhen City (CN); CHIEH YANG, Tu-Cheng (TW)

(73) Assignees: HON HAI PRECISION INDUSTRY CO., LTD., Tu-Cheng (TW); HONG FU JIN PRECISION INDUSTRY (ShenZhen) CO., Ltd., Shenzhen City (CN)

(21) Appl. No.: 13/217,495

(22) Filed: Aug. 25, 2011

(30) Foreign Application Priority Data
Apr. 25, 2011 (CN) 201110103376.1

(51) Int. Cl. F16M 13/00; F16B 2/20

(52) U.S. Cl. 248/201; 248/309.1; 248/316.7

(57) ABSTRACT

A connector mounting apparatus includes a hollow receiving member, and a securing bracket. The receiving member is used for receiving a connector interface. A securing opening is defined in the securing bracket to receive the receiving member. The securing bracket includes a first resilient contacting tab extending from a first edge of the securing opening. A free end of the first resilient contacting tab extends towards a center of the securing opening. The first resilient contacting tab is used for contacting the receiving member when the receiving member is received in the securing opening.

### BACKGROUND

1. Technical Field

The disclosure generally relates to connector mounting apparatus, especially, to a connector mounting apparatus with EMI (electro magnetic interference) shielding clips.

2. Description of Related Art

Equipped with removable covers, electronic components with USB interfaces are normally encased within a metal enclosure. Despite providing an “outer skin” for the computer, the covers are unshielded. The encased electronic components are prone to leak electromagnetic pollution from the covers. Such electromagnetic pollution can interfere with other electronic components outside the enclosure. Thus, shielding components with electromagnetic conductive material is necessary.

Thus, there is room for improvement within the art.

### BRIEF DESCRIPTION OF THE DRAWINGS

FIG. 1 is an exploded, isometric view of an embodiment of a connector mounting apparatus.

FIG. 2 is an isometric view of a securing bracket of the connector mounting apparatus of FIG. 1.

FIG. 3 is a view of an assembled connector mounting apparatus of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

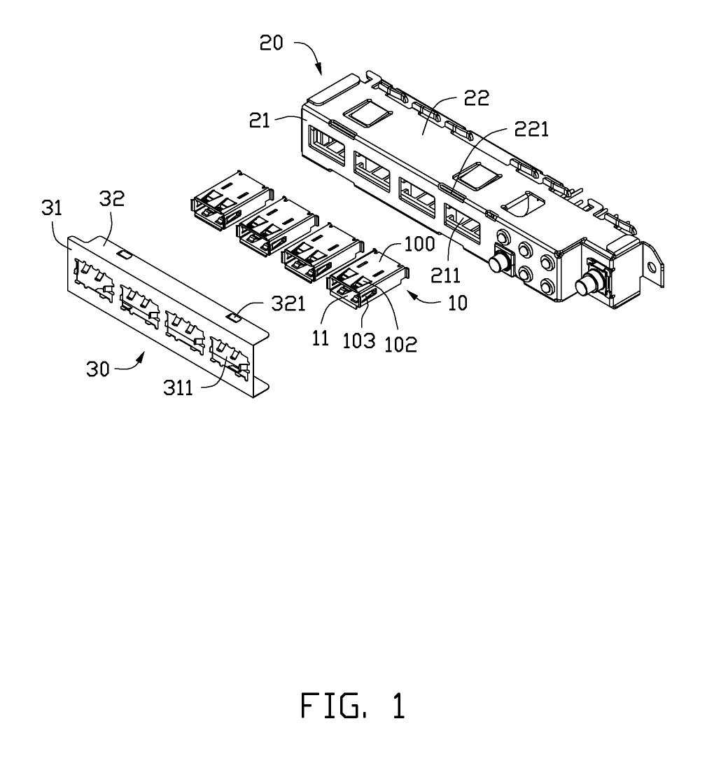

Referring to FIG. 1, one embodiment of a connector mounting apparatus is shown. The connector mounting apparatus includes four receiving members 10, a mounting bracket 20 for mounting the four receiving members 10, and a securing bracket 30 for securing the four receiving members 10 to the mounting bracket 20. Each receiving member 10 is used for receiving a connector interface.

Each receiving member 10 includes a main body 100. The main body 100 is hollow. A front opening 11 and a back opening (not shown) are defined in the receiving member 10. The front opening 11 is used for receiving a connector. In one embodiment, the connector is a USB connector. The back opening is used for receiving cables connected to a printed circuit board. Each receiving member 10 includes four first resilient resisting tabs 102 extending out from a pair of opposite sides of the main body 100. Each receiving member 10 includes two second resilient resisting tabs 103 extending in from another pair of opposite sides of the main body 100. The first and second resilient resisting tabs 102, 103 are used for contacting the connector interface.

The mounting bracket 20 includes a front panel 21 and two side panels 22 perpendicularly extending from opposite sides of the front panel 21. Two cutouts 221 are defined in a connection between each side panel 22 and the front panel 21. Four mounting openings 211 are defined in the front panel 21.

The securing bracket 30 includes a front plate 31 and two side plates 32 perpendicularly extending from opposite sides of the front plate 31. Four rectangular securing openings 311 are defined in the front plate 31 corresponding to the four receiving members 10. Each securing opening 311 has two parallel first edges 3113 and two parallel second edges 3114. The second edges 3114 are substantially perpendicular to the first edges 3113. The front plate 31 includes two first resilient contacting tabs 3111 extending from each first edge 3113. The front plate 31 includes a second resilient contacting tab 3112 extending from each second edge 3114. The first resilient contacting tabs 3111 correspond to the first resilient resisting tabs 102 of the receiving members 10. The second resilient contacting tabs 3112 correspond to the second resilient resisting tabs 103 of the receiving members 10. Free ends of each first resilient contacting tab 3111 and each second resilient contacting tab 3112 extend towards the center of corresponding securing opening 311 and each free end bends outwards. The securing bracket 30 includes two securing protrusions 321 extending from each side plate 32. The securing protrusions 321 can contact the side panel 22 via sliding over the cutout 221.

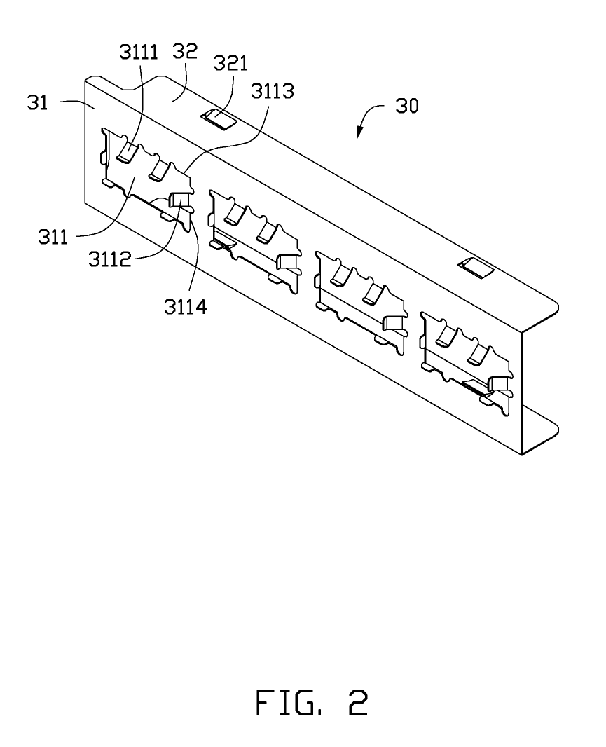

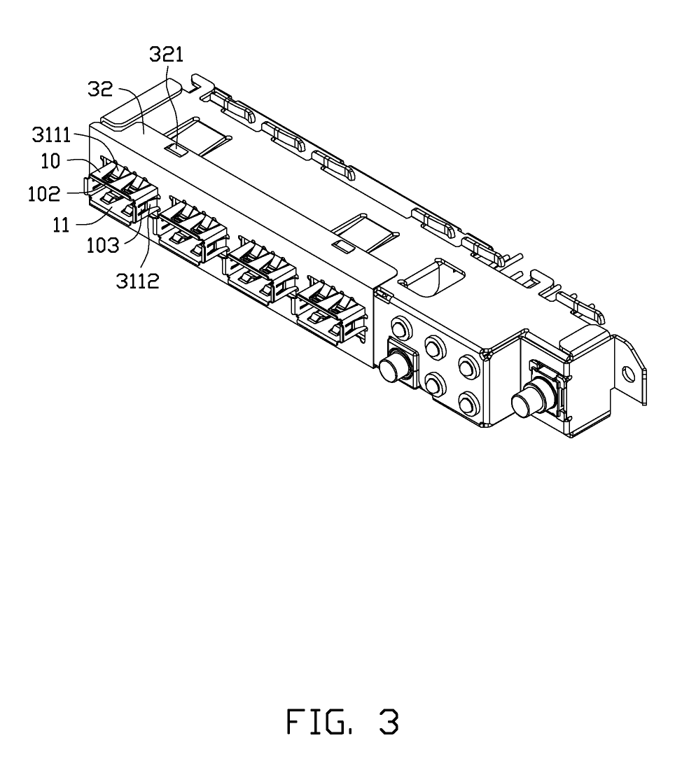

Referring to FIGS. 1 to 3, in assembly, each receiving member 10 is received in the mounting opening 211. The four securing openings 311 are aligned with the four receiving members 10. The securing bracket 30 is moved to the mounting bracket 20 to enable the securing protrusions 321 to be disposed in the cutouts 221. The securing bracket 30 is pushed towards the mounting bracket 20 to enable the securing protrusions 321 to move to contact the two side panels 22 of the mounting bracket 20. At this time, the receiving members 10 are received in the corresponding securing openings 311. The first resilient contacting tabs 3111 and the second resilient contacting tabs 3112 resist the receiving members 10. The securing bracket 30 is pushed until the first resilient contacting tabs 3111 and the second resilient contacting tabs 3112 abut the first resilient resisting tabs 102 and the second resilient resisting tabs 103 respectively. The first resilient contacting tabs 3111 and the second resilient contacting tabs 3112 resist the first resilient resisting tabs 102 and the second resilient resisting tabs 103 respectively, providing EMI shielding.

It is to be understood, however, that even though numerous characteristics and advantages have been set forth in the foregoing description of embodiments, together with details of the structures and functions of the embodiments, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A connector mounting apparatus, comprising:
a receiving member, the receiving member being hollow, the receiving member adapted to receive a connector interface; and
a securing bracket defining a securing opening receiving the receiving member, the securing bracket comprising a first resilient contacting tab extending from a first edge of the securing opening, a free end of the first resilient contacting tab extending towards a center of the securing opening; the first resilient contacting tab contacting the receiving member.

2. The connector mounting apparatus of claim 1, wherein the securing bracket comprises a second resilient contacting tab extending from a second edge of the securing opening, the second resilient contacting tab contacting the receiving member.

3. The connector mounting apparatus of claim 2, wherein the first edge is substantially perpendicular to the second edge.

4. The connector mounting apparatus of claim 2, wherein the receiving member comprises a main body for receive the connector interface and a second resilient resisting tab extending inward from the main body, the second resilient resisting tab contacting the second resilient contacting tab.

5. The connector mounting apparatus of claim 1, further comprising a mounting bracket, wherein the receiving member is mounted to the mounting bracket, the securing bracket comprising a front plate and two side plates perpendicularly extending from opposite sides of the front plate; the securing opening being defined in the front plate; and the side plates being secured to the mounting bracket.

6. The connector mounting apparatus of claim 5, wherein the securing bracket further comprises a securing protrusion extending inwards from each side plate, the mounting bracket comprising a front panel and two side panels extending from opposite sides of the front panel; the two securing protrusions being secured to the two side panels respectively.

7. The connector mounting apparatus of claim 6, wherein a cutout is defined in a connection between each side panel and the front panel, and the cutout guides the securing protrusions to move to the side panels when the securing bracket is mounted to the mounting bracket.

8. The connector mounting apparatus of claim 1, wherein the receiving member comprises a first resilient resisting tab extending inwards from the main body, the first resilient contacting tab contacting the first resilient resisting tab.

9. A connector mounting apparatus, comprising:
a mounting bracket defining a mounting opening therein;
a receiving member, the receiving member received in the mounting opening, the receiving member being hollow, the receiving member adapted to receive a connector interface; and
a securing bracket, the securing bracket comprising a front plate and two side plates perpendicularly extending from opposite sides of the front plate; a securing opening defined in the front plate; the securing bracket comprising a first resilient contacting tab extending from a first edge of the securing opening; the receiving member received in the securing opening and the first resilient contacting tab contacting the receiving member; and the front plate contacting the mounting bracket and the two side plate secured to the mounting bracket.

10. The connector mounting apparatus of claim 9, wherein the securing bracket comprises a second resilient contacting tab extending from a second edge of the securing opening, and the second resilient contacting tab contacts the receiving member.

11. The connector mounting apparatus of claim 10, wherein the first edge is substantially perpendicular to the second edge.

12. The connector mounting apparatus of claim 10, wherein the receiving member comprises a main body adapted to receive the connector interface and a second resilient resisting tab extending inward from the main body, the second resilient resisting tab contacts the second resilient contacting tab.

13. The connector mounting apparatus of claim 9, wherein the securing bracket further comprises a securing protrusion extending inwards from each side plate, the mounting bracket comprises a front panel and two side panels extending from opposite sides of the front panel, the mounting opening defined in the front panel; and the two securing protrusions are secured to the two side panels respectively.

14. The connector mounting apparatus of claim 13, wherein a cutout is defined in a connection between each side panel and the front panel, and the cutout is adapted to guiding the securing protrusions to move to the side panels.

15. The connector mounting apparatus of claim 9, wherein the receiving member comprises a first resilient resisting tab extending inwards from the main body, and the first resilient contacting tab is adapted to contact the first resilient resisting tab.
